(19) United States
(12) Patent Application Publication
(10) Pub. No.: US 2026/0275900 A1
(43) Pub. Date: Sep. 17, 2026

(54) AMMONIA PRE-CHAMBER INTERNAL COMBUSTION ENGINE

(71) Applicant: Regents of the University of Minnesota, Minneapolis, MN (US)

(72) Inventors: William F. Northrop, Minneapolis, MN (US); Seamus Patrick Kane, Minneapolis, MN (US); Shawn Reggeti, Minneapolis, MN (US)

(21) Appl. No.: 19/168,049

(22) PCT Filed: Mar. 28, 2024
(86) PCT No.: PCT/US2024/022016

§ 371 Date: Sep. 23, 2025

Related U.S. Application Data
(60) Provisional application No. 63/455,160, filed on Mar. 28, 2023.

(51) Int. Cl. F02B 19/10; F02B 19/12; F02B 43/12

(52) U.S. Cl. CPC F02B 19/108; F02B 19/1009; F02B 19/12; F02B 43/12

(57) ABSTRACT

Disclosed herein are methods and systems for operating a combustion engine, including: introducing, during an intake stroke of an internal combustion engine, a first volume of a fuel including ammonia into a pre-chamber, and a primary charge fluid into a main chamber; compressing, during a compression stroke of the internal combustion engine, the air into the pre-chamber such that the first volume of the fuel and the air form a compressed mixture; introducing, following the compression stroke, a second volume of the fuel into the compressed mixture to form a rich mixture; igniting the rich mixture in the pre-chamber; flowing, during a power stroke of the internal combustion engine, the ignited rich mixture into the main chamber; and exhausting the main chamber.

### CLAIM OF PRIORITY

This application claims priority under 35 USC § 119(e) to U.S. Patent Application Ser. No. 63/455,160, filed on Mar. 28, 2023, the entire contents of which are hereby incorporated by reference.

### FIELD OF THE DISCLOSURE

The disclosure relates to internal combustion engines and more specifically, to ammonia burning internal combustion engines utilizing active pre-chamber combustion.

### BACKGROUND

Ammonia is unsuitable as a direct replacement for current hydrocarbon fuels used in conventional internal combustion engines. The flame speed of ammonia is far lower than most hydrocarbon fuels. Therefore, the time required to propagate a flame across a combustion chamber of a spark-ignited engine is long, resulting in unburned ammonia emissions and engine misfire. Moreover, ammonia is extremely resistant to autoignition. Thus, it cannot be a direct replacement for diesel-like fuels in compression ignition engines at practical compression ratios. Overcoming these two limitations is desirable for ammonia to be cleanly and efficiently combusted in internal combustion engines.

These two shortcomings can be commonly solved by blending ammonia with another fuel to either increase flame speed for spark-ignited engines or increase autoignition propensity for compression ignition types. For spark-ignited engines, fuels like hydrogen or hydrocarbon fuels (e.g., natural gas, propane, gasoline, etc.), which have a higher flame speed than ammonia, are blended with the ammonia fuel. In the case of hydrogen blending with ammonia, only a small proportion of the total fuel charge (2-10% by volume) is used to enable spark-ignited engines to have equal performance to hydrocarbon fuels like natural gas.

Pre-chamber ignition entails placing a spark plug inside a small pre-chamber (~5-10% of the main chamber volume) adjacent to the main chamber in spark-ignited engines. Premixed fuel and air enter the pre-chamber during the compression stroke through small orifices. Near top dead center (TDC), the spark plug ignites the pre-chamber mixture, and strong turbulent jets from the orifices enter the main chamber, igniting the remainder of the fuel air mixture. Pre-chamber ignition is commonly used in high-speed, high-power engines to shorten combustion duration and improve efficiency. Pre-chambers are also used in heavy-duty engines for off-highway applications where turbulence enhancement from the turbulent jets is useful for improving combustion completion in otherwise quiescent main chambers.

Active pre-chamber technology incorporates both an ignition device and a fuel injector into the pre-chamber. In this way, fuel can be more precisely mixed with air (or fuel-air mixture) entering the orifices from the main chamber during the compression stroke. For hydrocarbon fuels, active pre-chambers have been used to allow main chamber combustion to proceed with overall fuel lean mixtures and to mitigate damaging abnormal combustion (i.e., knock), leading to increased engine thermal efficiency.

### SUMMARY

Disclosed herein is a method of using active pre-chamber combustion technology for burning ammonia as the sole fuel source in internal combustion engines. Taking advantage of ammonia's lack of coking due to the absence of carbon in the fuel, the ammonia pre-chamber engine operates with highly fuel rich mixtures in the pre-chamber and a lean or stoichiometric mixture in the main combustion chamber, resulting in net stoichiometric or slightly rich combustion overall.

In one aspect, the present disclosure provides a method of operating a combustion engine, including introducing, during an intake stroke of an internal combustion engine, a volume of a fuel including ammonia into the combustion engine, and a primary charge fluid into a main chamber; compressing, during a compression stroke of the internal combustion engine, the primary charge fluid into the combustion engine such that the volume of the fuel and the primary charge fluid form a compressed mixture; introducing, during the compression stroke, a different volume of the fuel into the compressed mixture into a pre-chamber to form a rich mixture; igniting the rich mixture in the pre-chamber; flowing, during a power stroke of the combustion engine, the ignited rich mixture into the main chamber; and exhausting the main chamber.

Examples may include one or more of the following features. In an example, the method may include inducing turbulent flow in the main chamber as the ignited rich mixture exits the pre-chamber. The volume may be injected into the pre-chamber or the main chamber of the combustion engine. The method may include igniting, following the flowing, the ignited rich mixture with an ignition device located in the main chamber. Igniting may include generating a spark, or a low-temperature plasma. The method may include controlling a temperature of the pre-chamber. Controlling the temperature of the pre-chamber may include heating the pre-chamber. Heating the pre-chamber may include flowing a heat exchange fluid around the pre-chamber, electrically heating a wall of the pre-chamber, or heating a resistive element within the pre-chamber. A fuel-air ratio may be sufficient to achieve stoichiometric combustion during a full stroke cycle of the combustion engine. The fuel-air ratio may be at least 3.57:1. The method may include introducing, prior to compressing, a premixed charge fluid through an intake into the main chamber. Igniting the rich mixture may include generating a low temperature plasma in the pre-chamber. In some cases, the volume of the fuel can be introduced into the pre-chamber and the different volume can be introduced into the main chamber or an intake port of the combustion engine.

In another aspect, the present disclosure provides an ammonia-burning engine including a plurality of combustion cylinders, each combustion cylinder including: a main chamber; a piston configured to move within the main chamber; a pre-chamber fluidly coupled to the main chamber, where an internal volume of each pre-chamber is at least 5% v/v of an internal volume of the corresponding main chamber at top dead center; a fuel injector configured to inject a liquid fuel may include ammonia into the pre-chamber; and an ignition device configured to generate a spark within the pre-chamber.

Examples may include one or more of the following features. In an example, the engine may include a temperature control unit operatively coupled to each pre-chamber. The temperature control unit is configured to heat the pre-chamber to a temperature in a range from 50° C. to 250° C. The temperature control unit can be a closed loop heater, or a resistance heater. At least 99.5% of the ammonia may be converted to combustion products. The engine can achieve a compression ratio in a range from 10:1 to 20:1. The ignition device can be a spark plug, or a hot surface ignitor, or a nanosecond pulsed power supply to provide a low temperature plasma. The engine each combustion cylinder may include a second fuel injector arranged to inject a liquid fuel into the main chamber, and a second ignition device configured to cause a spark within the main chamber. The second ignition device can be a spark plug, a hot surface ignitor, or a nanosecond pulsed power supply to provide a low temperature plasma. The piston may include a re-entrant bowl or shallow-dish in an upper surface of the piston. The pre-chamber may include a protrusion extending away from an inner volume of the pre-chamber and the fuel injector is arranged to inject fuel into the protrusion. The engine may include a high surface area heating element arranged in the pre-chamber arranged such that the fuel may be injected onto the high surface area heating element. The pre-chamber can include orifices fluidly coupling the pre-chamber to the main chamber. The orifices can be configured to prevent choked flow when fluid is flowing through the orifices.

In another aspect, the present disclosure provides a method of operating a combustion engine, including introducing, during an intake stroke of an internal combustion engine, a volume of a fuel including ammonia into a pre-chamber of the combustion engine, and a primary charge fluid into a main chamber; compressing, during a compression stroke of the internal combustion engine, the primary charge fluid into the pre-chamber such that the volume of the fuel and the primary charge fluid form a rich compressed mixture; igniting the rich compressed mixture in the pre-chamber; flowing, during a power stroke of the combustion engine, the ignited rich mixture into the main chamber; and exhausting the main chamber.

Particular implementations of the subject matter described in this specification can be implemented so as to realize one or more of the following technical advantages.

The ammonia pre-chamber internal combustion engines described herein operate without externally provided hydrogen or secondary fuels, which increases the flexibility of the technology for use across a broad range of use-cases. This avoids storage of two fuels at the point of application and can reduce ammonia cracking to produce the hydrogen for combustion. However, in some embodiments, ammonia cracking using waste heat from the engine (e.g., thermochemical recuperation) and the ammonia pre-chamber technology can be used in concert to further increase engine thermal efficiency (see, for instance, the contents of U.S. Pat. No. 10,815,123, the contents of which are hereby incorporated by reference.)

The use of an active pre-chamber ignition strategy changes the fuel reactivity properties of ammonia in the cylinder. Fuel-rich combustion in the pre-chamber partially burns the ammonia and uses the released heat/energy to crack the remaining ammonia into hydrogen and nitrogen at the point of use. Hot, turbulent hydrogen-containing fluid is then discharged into the main chamber, igniting the overall fuel and air mixture. Rich combustion of ammonia is not limited by solid carbon formation (i.e., coking) like it is for hydrocarbon fuels because the molecule contains no carbon. Therefore, the internal surfaces and orifices of the pre-chamber will not become fouled at very rich mixtures where hydrogen production is favored. Even oxygen-containing hydrocarbons like ethanol and methanol are limited by carbon formation in rich combustion environments, a scenario not possible for ammonia.

Highly turbulent jets of fluid are propelled through orifice(s) into the main cylinder, driven by the increased pressure compared to the main chamber from exothermic reactions in the pre-chamber. Hydrogen from the rich pre-chamber reactions rapidly diffuses into the main chamber, increasing the flame speed of the overall mixture. The highly turbulent jets also violently physically mix with the main air charge, heating them and overcoming ammonia's resistance to ignition. The overall process results in a more rapid burn in the main chamber, promoting complete combustion and higher engine thermal efficiency due to shorter combustion duration.

Internal combustion engines utilizing the technologies described herein have a clean ammonia combustion emissions profile which results in primarily water and diatomic nitrogen as byproducts. Pre-chamber ignition systems can reduce or eliminate undesirable pollutant emissions like unburned ammonia, oxides of nitrogen (NOx) and nitrous oxide (N₂O) through rapid combustion and turbulent mixing. The technologies achieve net stoichiometric or slightly rich ammonia combustion at high temperature thereby reducing the formation of N₂O, a potent greenhouse gas.

The details of one or more embodiments are set forth in the accompanying drawings and the description below. Other features and advantages will be apparent from the description and drawings, and from the claims.

### DESCRIPTION OF DRAWINGS

FIG. 1 is a schematic illustration of an internal combustion engine having an active pre-chamber.

FIG. 2 is a diagrammatic illustration of a full engine cycle of the combustion engine and stages of injection, ignition, and combustion of the fuel-air mixture within the pre-chamber.

FIG. 3 is a diagrammatic illustration of the ignition and subsequent combustion of fuel-air mixture within the pre-chamber.

FIG. 4 are diagrammatic illustrations of three example pre-chambers having a temperature control unit to control a temperature of the pre-chamber.

FIGS. 5A and 5B are diagrammatic illustrations of a pre-chamber having a protrusion in which the fuel injector is recessed from the inner volume.

FIG. 6 is a flow chart diagram of a method of operating a combustion engine.

FIG. 7 is a diagrammatic illustration of a full engine cycle performing a single fuel injection within the pre-chamber.

FIG. 8 is a diagrammatic illustration of a full engine cycle performing a fuel injection within the pre-chamber and a fuel injection before the main chamber.

FIG. 9 is a diagrammatic illustration of a full engine cycle performing a fuel injection within the pre-chamber and a fuel injection within the main chamber.

FIG. 10 is a schematic illustration of an internal combustion engine having an active pre-chamber and associated volumes.

FIG. 11A is a series of three plot diagrams showing ammonia combustion modeling results.

FIG. 11B is a series of three plot diagrams showing enlarged portions of the ammonia combustion modeling results of FIG. 11A.

FIG. 12 is a series of three plot diagrams showing ammonia combustion modeling results when spark timing is varied.

In the figures, like references indicate like elements.

### DETAILED DESCRIPTION

The systems and devices described herein facilitate the combustion of ammonia as the sole fuel for internal combustion engines. The systems and devices allow existing internal combustion engines to use ammonia as a drop-in replacement for hydrocarbon fuels with minor modifications to the combustion chamber and fuel delivery system.

Pre-chamber combustion systems consist of a pre-chamber having a small volume (~5-10% of the main chamber volume) with small orifices that fluidly connect into the main combustion chamber. Non-active pre-chamber systems induct fuel and air already in the main combustion chamber during the compression stroke and ignite them with a spark plug. High velocity flame jets emerge into the combustion chamber, which then ignite the main charge. In active pre-chamber systems, a fuel injector is also located in the pre-chamber. Fuel is injected into the pre-chamber to create the same turbulent environment as in passive systems to allow more precise mixture control of the overall combustion process.

Ammonia is a viable fuel for spark-ignited engines. However, ammonia alone has combustion properties which difficult to use in traditional combustion engines, and a higher reactivity fuel (e.g., 2-10% hydrogen by volume in the fuel) must be blended to enable stable operation. This disclosure describes systems and methods which allow for the necessary hydrogen to be created in the combustion chamber using an active pre-chamber system.

The concept disclosed is an active pre-chamber system where ammonia mixed with intake air is inducted into the cylinder during the intake valve opening (IVO) period to create a lean or stoichiometric fuel-air mixture in the main chamber. During compression, the main chamber mixture is driven into the pre-chamber and compressed. Additional ammonia is then injected into the pre-chamber after intake valve closing (IVC) in one or multiple injections to create a rich mixture in the pre-chamber. Approximately 5-10% of total ammonia fuel is injected in the second injection(s).

The general concept disclosed also has the potential to inject all the needed fuel into the combustion chamber using two or more injections. In this embodiment, during the intake stroke, ammonia is injected into the pre-chamber during the IVO period when only air is inducted into the chamber through the intake valve(s). Ammonia is flows into the main chamber through the pre-chamber orifices, mixing with incoming air to form a lean or stoichiometric mixture within the cylinder by IVC. During compression, the main chamber mixture is driven into the pre-chamber and compressed. Additional ammonia is then injected into the pre-chamber after intake valve closing (IVC) in one or multiple injections to create a rich mixture in the pre-chamber. Approximately 5-10% of total ammonia fuel is injected in the second injection(s).

Ammonia can be injected into the pre-chamber as a fluid. As used herein, a fluid refers to a gas, a liquid, or a combination of gas and liquid (e.g., a mist or spray). In the case of fluidic injection, additional time may be required to allow the full amount of fuel required per cycle to be added due to its inherently low density compared to liquid ammonia. Liquid injection allows for faster mass flow rates of ammonia into the cylinder but leads to cooling in the pre-chamber to overcome ammonia's latent heat of vaporization.

The concept disclosed includes the provision to heat the pre-chamber using external means. Heating the pre-chamber can overcome cooling from liquid ammonia injection and can allow richer fuel-air mixtures to be ignited. Research has shown that rich mixture ignition is sensitive to temperature with higher gas temperatures allowing richer mixtures to be ignited by a conventional spark plug.

The rich pre-chamber mixture is ignited following the spark event, creating a net exothermic reaction forming primarily hydrogen (H₂), water (H₂O), diatomic nitrogen (N₂) and unreacted ammonia (NH₃). During the power stroke of the engine, the pre-chamber products flow through orifices connecting the pre-chamber and the main chamber due to the pressure difference between the pre-chamber and main chamber. The products may be still reacting when they emerge from the pre-chamber, or they may be hot, quenched fluids containing the products of the rich reaction including radical species. The pre-chamber products sent into the main chamber enter because of higher pressure in the pre-chamber than the main chamber due to the injected fuel mass and heating from the exothermic reactions.

As the pre-chamber products enter the main chamber at high velocity, main-chamber turbulence is increased, which increases physical mixing and heating of the main chamber fluids. This, in turn, increases the propensity for the main chamber ammonia-air mixture to ignite and burn. Heating from the pre-chamber products also results in higher combustion efficiency because more of the fuel is burned by the end of the power stroke.

Hydrogen (H₂) generated during the rich pre-chamber reactions enter the main chamber rapidly and mix with the fluids therein. H₂ has a higher differential diffusivity than other gases in the main chamber, especially at high pressure, causing rapid mixing. Rapidly diffusing H₂ into premixed ammonia-air in the main chamber enhances the flame speed of the overall mixture, resulting in faster combustion and more expedient ignition. This increases the overall combustion efficiency and shortens the ignition delay. By shortening ignition delay and combustion duration, ammonia can burn near-completely (e.g., >98% combustion, >99% combustion, >99.5% combustion, or >99.9% combustion) depending on combustion chamber design, resulting in low levels of undesirable combustion products like unburned ammonia (NH₃), hydrogen (H₂), NOx, and nitrous oxide (N₂O).

Addition of H₂ from the pre-chamber can also induce alternative combustion modes to turbulent flame propagation typical of spark-ignited engines. Due to the high resistance to knock (e.g., high octane number) of ammonia, it has been shown to combust in a mode known as spark-assisted compression ignition (SACI) when burned in spark-ignited engines. The presence of 2-10% hydrogen can enhance the SACI effect and allow greater control of combustion phasing as a function of spark-timing. The ammonia pre-chamber provides the additional hydrogen, mixing, and thermal energy necessary to initiate SACI in the main chamber.

As used herein, a full internal combustion engine cycle includes four sequential strokes: an intake stroke during which combustion gas, e.g., air, and/or a fuel flows into a combustion cylinder; a compression stroke during which the air and fuel are compressed within the combustion cylinder; a expansion stroke during which the air and fuel are ignited and expand; and an exhaust stroke during which the combustion products are exhausted from the combustion cylinder. The portion of the engine cycle consisting of the compression stroke and expansion stroke is referred to as the full engine cycle. Further, terms describing positions of the piston within the engine cycle include bottom dead center (BDC), and top dead center (TDC). BDC occurs when the piston creates a maximum volume and TDC occurs when the piston creates a minimum volume within the main chamber. The beginning and/or end of different strokes of the engine cycle can be defined in various ways, including when a valve (e.g., an intake or exhaust valve) opens or closes, or when the piston achieves BDC or TDC.

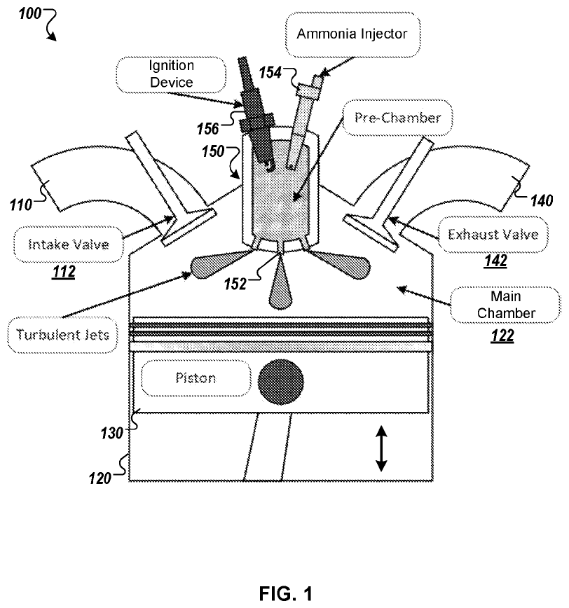

FIG. 1 is a schematic illustration of a cross section of a complete engine cylinder assembly 100 of an ammonia pre-chamber internal combustion engine. Broadly, the internal combustion engine cylinder assembly 100 mixes air with ammonia and combusts the mixture at stoichiometric or slightly rich overall fuel-air mixtures to produce high temperature and pressure, which is then expanded during the expansion stroke to produce work from the internal combustion engine. The engine cylinder 100 includes the intake port 110, cylinder 120, piston 130, exhaust port 140, and pre-chamber 150. The volume of the cylinder 120 between the piston 130 and the pre-chamber 150 is termed the main chamber 122.

In general, the ammonia internal combustion engine can include more than one engine cylinder assembly 100 with associated intake port 110, cylinder 120, piston 130, exhaust port 140, and pre-chamber 150, e.g., two, four, eight, ten, twelve, or sixteen engine cylinder assemblies 100. Each of the assemblies100 of the internal combustion engine operates in a coordinated fashion, e.g., share a commons full engine cycle at staged intervals, to power the combustion engine. Compression, combustion, and expansion enables the reciprocating motion of the piston 130 within the cylinder 120 and defines various stages of the internal combustion engine full engine cycle. In general, motion of the piston 130 toward the pre-chamber 150 will be referred to herein as ‘upward,’ while motion of the piston 130 away from the pre-chamber 150 will be referred to as ‘downward.’

In the engine cylinder assembly 100 and at the beginning of a full engine cycle, gas previously inducted through the intake port 110 is trapped after the intake valve 112 is closed to form a primary charge in main chamber 122 and the pre-chamber 150 due to the open connection between the two through orifices 152. The primary charge can include fluids, including but not limited to, air, ammonia, hydrogen, or combinations thereof. The terms primary charge and primary charge fluid may be used interchangeably herein.

In general, the orifices 152 provide a total cross-sectional area (e.g., the sum of the cross-sectional area of all orifices 152, TCA) to prevent a choked flow during the engine cycle. Without being bound by theory, ‘choked flow’ is a flow effect in which fluid velocity of a flowing fluid is limited when the fluid flows through a constriction (e.g., such as fluid passing through the orifices 152 between the pre-chamber 150 and the main chamber 122). Choked flow can occur when a fluid flows between the pre-chamber 150 and the main chamber 122 in at least one, or in all steps of the engine cycle, including, but not limited to, during the intake stroke, the compression stroke, the power stroke, and the exhaust stroke steps.

The TCA of the orifices 152 is sufficiently small to achieve turbulent flow as fluid flows through the orifices 152. Turbulent flow is achieved at or below a ratio of the TCA to the pre-chamber 150 volume (V_{pc}). Prechamber volume is also dependently related to the main chamber 122 volume (V_{mc}), for example, as expressed by a specific ratio of the pre-chamber 150 volume and the main chamber 122 volume (e.g., 5% v/v V_{pc}/V_{mc}). Suitable turbulent flow can be achieved in a range from 0.3 m⁻¹ to 15.0 ml (e.g., 0.4 m⁻¹ to 12.0 m⁻¹, 0.5 m⁻¹ to 10.0 m⁻¹, 0.6 m⁻¹ to 8.0 m⁻¹, 0.7 m⁻¹ to 7.0 m⁻¹, or 0.75 m⁻¹ to 4.0 m⁻¹) total cross-section area to pre-chamber 150 volume (TCA/V_{pc}).

During the full engine cycle, ammonia is injected into the combustion engine and is subsequently ignited using an ignition device, such as ignition device 156. The ammonia fuel can be introduced in the pre-chamber 150, or the main chamber 122, or both. Exothermic reactions occurring after ignition in the pre-chamber 150 create a differential pressure between the pre-chamber 150 and the main chamber 122. The ignited fuel increases the chamber pressure within the pre-chamber 150. Product fluids emerge into the main chamber 122 driven by the pressure difference through orifices 152 as turbulent jets. In one example, the orifices 152 provide sufficient flow to prevent choked flow while the ignited fuel under increased pressure is flowing between the pre-chamber 150 and the main chamber 122 following ignition.

The turbulent jets of hot fluids containing hydrogen and other reactive products emerge into the main chamber 122. Diffusion and physical mixing of products from the pre-chamber 150 with the primary charge in the main chamber 122 increases the flame speed and heats the primary charge fluids. The remainder of the primary charge is then ignited and combusted. As the piston 130 moves downward during the combustion portion expansion stroke, the heat released creates an increase in pressure inside the main chamber 122 and pre-chamber 150 due to the open connection from the orifices 152.

When the combustion reaction is complete during the expansion stroke of the full engine cycle, a pressure difference between the main chamber 122 and the pre-chamber 150 causes additional gas to emerge from the orifices 152. At the end of the full engine cycle portion of the full engine cycle, the exhaust valve 142 opens and the remaining gas is pushed through the exhaust port 140 to clear the main chamber 122 of combustion products. During the exhaust stroke, additional residual fluids from the previous power cycle also emerge from the pre-chamber 150 to the main chamber 122 due to an open connection through orifices 152, which are then ejected through the exhaust valve 142.

The full engine cycle begins again as the piston 130 moves downward. Fresh air flows into the main chamber 122. The piston 130 shown in FIG. 1 includes a flat upper surface (e.g., the surface facing the main chamber 122), though other geometries can be considered. In some examples, the upper surface of the piston 130 includes bowls, depressions, or shallow dishes in the upper surface which are known in the art as open or re-entrant bowls. A re-entrant bowl is defined by a top opening of the bowl in the piston being smaller in diameter than the maximum bowl diameter.

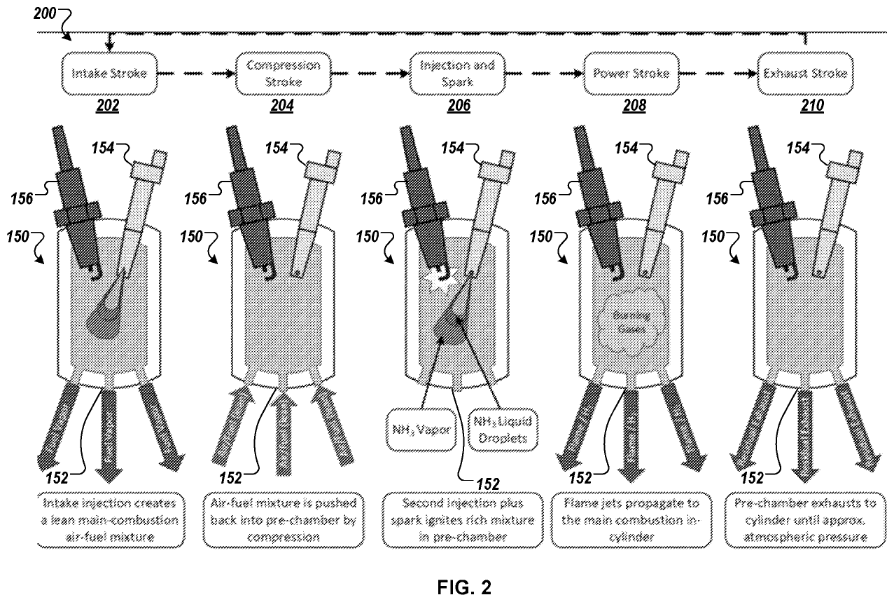

More detail of the full internal combustion engine cycle is shown with reference to FIGS. 1 and 2. FIG. 2 includes a diagram of the full engine cycle 200 as experienced by the pre-chamber 150. The full engine cycle includes four strokes, e.g., upward or downward motions of the piston 130, plus an injection and spark step. The full engine cycle 200 includes an intake stroke 202 during which the piston 130 is moving downward in the cylinder 120. During the intake stroke 202, the intake port 110 received gas from an intake manifold. The gas sent into the intake port can consist of air, an air-ammonia mixture, or a mixture of air, ammonia, and hydrogen. The gas is then inducted into the cylinder 120 is gated by an intake valve 112 timed to allow air into the cylinder 120 during the intake stroke of a full engine cycle.

In examples using supplementary fluid injected into the intake port 110 or main chamber 122, the supplementary fluid can be injected into the air upstream of the intake valve 112. Secondary fluid could consist of ammonia, hydrogen, or a mixture of the two. Additionally, or alternatively, the supplementary fluid can be injected directly into the main chamber 122 by a second fuel injector.

During the intake stroke 202, a pressure difference is created between the main chamber 122 and the pre-chamber 150. Fluid from the pre-chamber 150 flows into the main chamber 122 through orifices 152. Ammonia fuel is injected into the combustion engine for powering the cycle. In examples using ammonia injection into the pre-chamber 150 during the intake stroke, ammonia is injected using a fuel injector 154. Fuel vapor flows between the pre-chamber 150 and main chamber 122 and mixes with the fluid entering the main chamber 122 from the intake port 110. This mixture could create a combustible mixture inside the main chamber 122 that is lean of stoichiometric, stoichiometric, or slightly rich of stoichiometric.

Alternatively, the mixture could create a combustible mixture inside the main chamber 122 that achieves a desirable equivalence ratio (φ). Without wishing to be bound by theory, φ is defined as the mass ratio of fuel to air in a mixture divided by the stoichiometric mass ratio of fuel to air. If a fuel-air mixture is stoichiometric, φ is equal to 1. A lean φ (less than 1) is defined by a fuel-air ratio that is below stoichiometric, e.g., below the fuel-air ratio that all ammonia present in the mixture can be oxidized by the oxygen contained in air. Alternatively, a rich φ (greater than 1) is defined by a fuel-air ratio is that is above stoichiometric e.g., where insufficient oxygen is present in the mixture oxidize the ammonia. The stoichiometric ratio of air:ammonia is 3.57:1 by volume, or 6.06:1 by mass.

Following the intake stroke 202, the intake valve 112 is closed, creating a primary charge in the cylinder 120. During the compression stroke 204, the piston 130 moves upward and pushes the fuel-air mixture into the pre-chamber 150. The piston 130 forces the primary charge fluids, which could include a fuel-air mixture, air, or diluted air, into the pre-chamber 150 through orifice(s) 152 which separate the inner volume of the cylinder 120 from the inner volume of the pre-chamber 150.

In general, a ratio between the inner volume of the main chamber 122 and the pre-chamber 150 is at least 5% v/v established with the piston 130 is in its highest position, or top dead center (TDC). For example, at TDC the volume ratio of the main chamber 122 and the pre-chamber 150 can be in a range from 5% to 25% v/v (e.g., 5% to 10% v/v, 5% to 15% v/v, 5% to 20% v/v, 8.5% to 15% v/v, 10% to 15% v/v, 10% to 20% v/v, 10% to 25% v/v, 15% to 20% v/v, 15% to 25% v/v, or 20% to 25% v/v). The pre-chamber 150 for ammonia engines has a larger volume compared to pre-chambers for hydrocarbons due to ammonia's lower energy content per unit mass and the need to achieve enough thermal energy and rich products to ignite the main chamber mixture.

The volume of the main chamber 122 changes from a maximum at bottom dead center (BDC), to a minimum at the end of the compression stroke 204 when the piston (130) is at TDC. As such, the total combined volume of the main chamber 122 and the pre-chamber 150 changes from a maximum at BDC to a minimum at TDC. The ratio of the maximum volume to the minimum volume (i.e., volume at BDC minus volume at TDC) is termed ‘compression ratio’ and affects the overall characteristics of the combustion reaction. In ammonia-fueled engines, such as those utilizing engine cylinder assemblies 100, pre-ignition (or “knock”) is as prevalent as in hydrocarbon fueled engines. In the ammonia combustion engine, compression ratios from 10:1 to 20:1 (e.g., 15:1, or 17:1) are achieved, which is above the compression ratios achieved used in spark-ignited hydrocarbon engines with premixed air and fuel combustion systems.

The pre-chamber orifice(s) 152 are cylindrical holes which facilitate fluid, e.g., gas and/or liquid, flow between the cylinder 120 and the pre-chamber 150 during the full engine cycles of the combustion engine. Cylindrical orifice(s) 152 can minimize flow resistance of fluid traversing the orifice(s) 152 between the pre-chamber 150 and the main chamber 122. The orifice(s) 152 can be straight-walled or can include baffling to increase the level of turbulent flow in fluids passing through the orifice(s) 152.

The number, geometry, and orientation of the orifice(s) 152 can be configured to achieve high gas flow rates with low pressure drop and, optionally, high mixing swirl turbulence when mixing injected fuel with the air in the pre-chamber 150 and/or the main chamber 122. Examples of variable geometry parameters of the orifice(s) 152 include cross-sectional shape (e.g., circular, oval), or greatest dimension (e.g., diameter). The optionally induced swirl can increase the mixing speed of the combustion air and ammonia beneficially increasing the reactivity of the mixture, generating increased heat, and facilitating maximal combustion efficiency when the mixture is combusted.

During the injection and spark step (206), the fuel injector 154 injects ammonia into the pre-chamber 150 mixing with the primary charge fluid previously inducted into the pre-chamber 150 during the compression stroke 204 such that a desired mixture of primary charge fluid and ammonia forms. In implementations in which the combustion engine includes multiple engine cylinder assemblies 100, the ammonia can be fed to each fuel injector 154 of each pre-chamber 150 through individual lines fed from a common source, such as a fuel distributor and pump system.

The quantity of ammonia injected into the pre-chamber 150 is controlled such that a desired φ is achieved in the pre-chamber 150. Injection(s) of ammonia into the pre-chamber during the injection and spark event 206 is controlled such that a rich φ of greater than 1.2 is achieved by the end of the injection event. In one example, the φ is in a range from 1.05≤φ≤2.0, e.g., 1.1≤φ≤1.95, 1.025≤φ≤1.75, 1.05≤φ≤1.65. The φ is greater than traditional hydrocarbon-based combustion engines because ammonia does not generate carbon byproducts, e.g., soot, when reacted with air at high φ values. The high φ value facilitates the production of hydrogen during pre-chamber reactions, which increases the reactivity of the overall fuel when the pre-chamber products enter the main chamber 122 and mix with the primary charge therein. This increased reactivity increases the overall combustion efficiency of the engine and facilitates near-complete combustion of the ammonia into nitrogen products and water.

The ammonia injected into the pre-chamber 150 can be a fluid, e.g., a gas and/or a liquid. In the example where ammonia injected is a liquid, a liquid jet or jets of ammonia are atomized into smaller droplets near the fuel injector 154. These droplets evaporate in the pre-chamber 150, eventually mixing completely with the fluid in the pre-chamber creating the desired mixture therein.

When the desired fuel-air mixture is achieved in the pre-chamber 150, an ignition device 156 (e.g., a spark plug) ignites the fuel-air mixture in the injection and spark step 206. The ignition device 156 is used to initiate reactions such as combustion, partial oxidation, and ammonia decomposition. The ignition device 156 can use a thermal arc, typical of spark-ignited engines, or it could be a specialized design using a nanosecond pulsed power supply to provide a low temperature plasma. Such a low temperature plasma may provide additional radical species that lead to additional reaction pathways to produce hydrogen and other highly reactive species useful in main chamber 122 combustion. The ignition device 156 could also be a high energy ignition system, including one that uses multiple sparks, laser ignition system, or any other high energy system known to practitioners in the art.

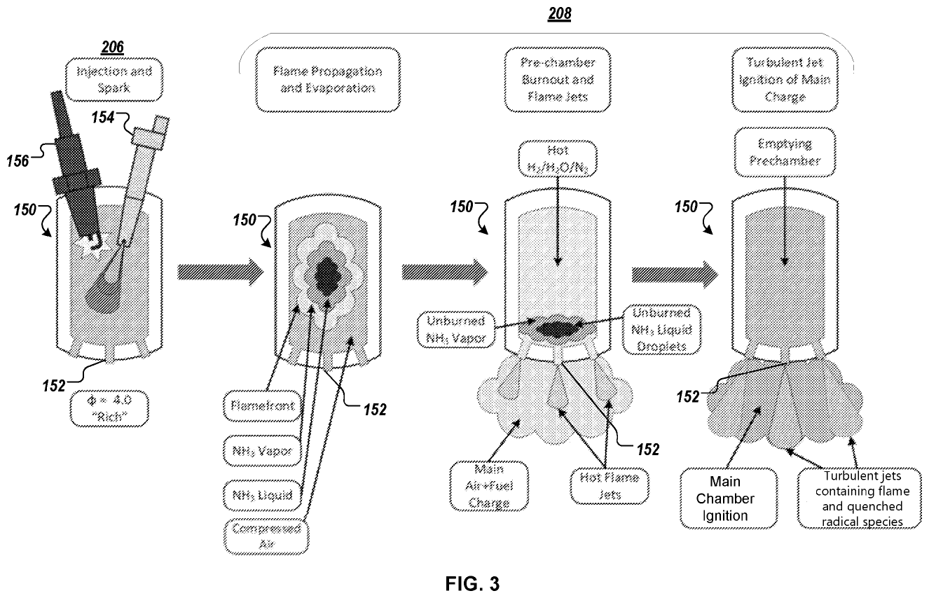

The rich fuel-air mixture in the pre-chamber 150 includes more NH₃ that can be combusted within the timescale of the combustion flame front exiting the pre-chamber 150. FIG. 3 is a diagram illustrating a breakout of steps occurring in the injection and spark step 206, and the expansion of the fuel-air mixture during the power stroke 208. From left to right, the first breakout image illustrates the injection and spark step 206 during which the fuel injector 154 injects ammonia e.g., liquid ammonia injection, and the ignition device 156 ignites the fuel-air mixture within the pre-chamber 150.

The second breakout image, following the directional arrows in FIG. 3, illustrates the propagating reaction in the pre-chamber 150. Representative areas illustrating the exemplary flame front, NH₃ vapor and liquid phases (in the case of liquid ammonia injection), and compressed air are shown. The flame front represents the chemical reactions occurring within a narrow zone in which the vapor ammonia is reacting with oxygen to form reaction products such as, but not limited to, hydrogen, water, and nitrogen species. The propagating flame front consumes ammonia outward from the ignition device 156 and further compresses the surrounding fluid mixture. This compression causes unreacted mixture to escape the pre-chamber 150 into the main chamber 122 through the orifice(s) 152. The unreacted mixture from the pre-chamber 150 mixes with the primary charge in the main chamber 122.

The third breakout image in FIG. 3 illustrates the reaction front in the pre-chamber 150 emerging from the orifices 152. The hot jets emerging from the orifice(s) 152 contain fuel and air in the process of burning (e.g., an active flame), quenched radical species-containing fluids, or a combination thereof. Fluids emerge at high velocity due to the pressure difference between the pre-chamber 150 and main chamber 122 generating turbulence in the main chamber 122. The hot, hydrogen containing fluids mix with the primary charge in the main chamber 122. Hydrogen diffuses through the main chamber, increasing the flame speed of the ammonia-air mixture. Fuel flow to the engine cylinder assembly 100 is controlled, both through management of primary charge and pre-chamber injection, such that the overall fuel-air mixture is combusted at stoichiometric, or slightly rich equivalence ratio e.g., φ in the range of 1.0 to 1.1, to control emissions of N₂O from the engine. Onset of turbulence in the fluid flow between the pre-chamber 150 and the main chamber 122 can occur when the prechamber pressure rises at least 1 bar over the main chamber pressure.

The hot, radical-containing turbulent jets ignite the fuel-air mixture within the main chamber 122 during the power stroke 208, which generates heat, and increases the main chamber pressure. The combustion of remaining fuel within the main chamber 122 increases pressure to the maximum cycle value, exerting force on the piston 130, resulting in work output. The presence of the turbulent jets within the main chamber 122 decreases the combustion duration. Secondary spark-assisted compression ignition also occurs because of the increased main chamber pressure, further shortening the combustion duration. Shorter combustion duration from an estimated 60-80 degrees of engine crank-angle to 15-30 degrees increases thermal efficiency of the engine by allowing earlier expansion of high-pressure fluid in the cylinder as the piston 130 moves toward BDC.

Referring again to FIGS. 1 and 2, the completion of the overall combustion reaction results in burned fluids within the pre-chamber 150 and main chamber 122. The exhaust stroke 210 begins near BDC, e.g., when the piston 130 is furthest from the pre-chamber 150, and accelerating upward. An exhaust valve 142, which seals the exhaust port 140 against fluidic flow during the intake stroke 202, compression stroke 204, and power stroke 208 opens, permitting motion of the piston 130 to force the burned fluids out of the main chamber 122 through the exhaust port 140. The exhaust valve 142 closes at the end of the exhaust stroke 210. The full engine cycle 200 is repeated following the exhaust stroke 210 by the initiation of the intake stroke 202.

In some examples of, the ammonia pre-chamber internal-combustion engine, the pre-chamber 150 includes a temperature control unit which regulates the temperature of the pre-chamber 150 body and the temperature of the fluid contained therein, i.e., its inner volume. Controlling the temperature of the pre-chamber 150 and/or its inner volume can facilitate increased control of the characteristics of the pre-chamber reactions, such as ignition propensity or reaction completion. In general, higher inner volume temperature allows for ignition of more fuel-rich mixtures than if it is not heated, a characteristic desired for starting a cold engine or for decreasing main chamber 122 combustion duration through generation of more hydrogen in the pre-chamber reactions. The temperature control unit can be configured to heat the pre-chamber to a temperature in a range from 50° C. to 250° C. (e.g., 50° C. to 100° C., 50° C. to 150° C., 50° C. to 200° C., 100° C. to 200° C., 100° C. to 250° C., 100° C. to 150° C., 150° C. to 200° C., or 150° C. to 250° C.).

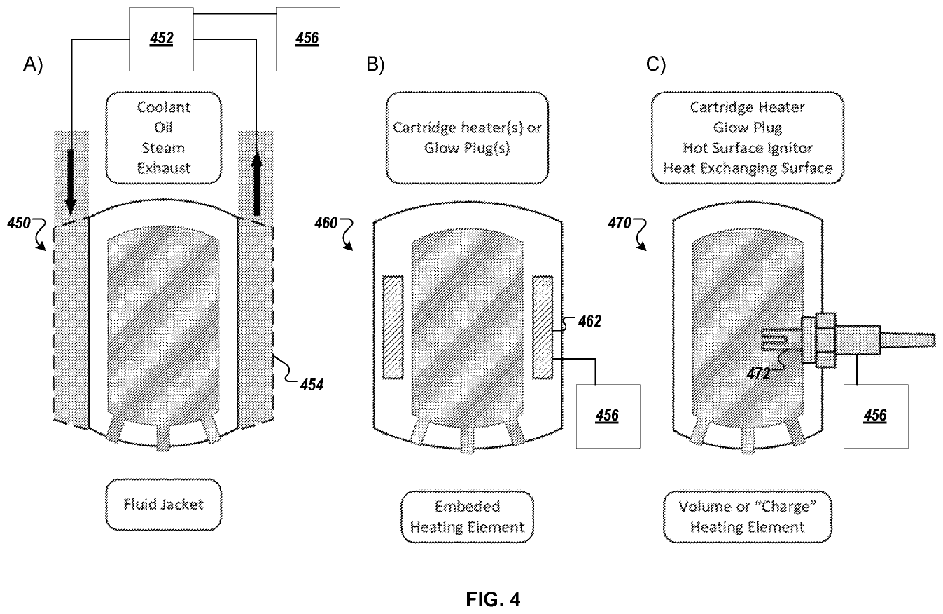

FIG. 4 shows three example pre-chambers in examples A, B, and C. Example A shows a closed loop heater including a fluid jacket 454 surrounding a pre-chamber 450 and a pump 452 in fluid communication with the fluid jacket 454. Examples of the thermal regulation fluid can include engine coolant, engine oil, steam, or combustion exhaust fluids. The temperature control unit 456 operates the pump 452 to circulate the thermal regulation fluid within the fluid jacket 454 and thereby control the temperature of the pre-chamber 450. In some examples, the temperature control unit 456 is part of the onboard temperature monitoring system within the ammonia pre-chamber internal combustion engine in which the pre-chamber 450 is installed. In examples using a fluid jacket 454 and pump 452 to control the temperature of the pre-chamber 450, the temperature control unit 456 controls the temperature in a range from 50° C. to 150° C.

Example B shows an electrical heating element 462 embedded within the walls of a pre-chamber 460 and in connection with the temperature control unit 456. In general, the embedded electrical heating element 462 is functional to achieve temperatures higher than temperatures achieved with the use of a fluid jacket 454 due to the electrical heating element 462 directly heating the pre-chamber 460 instead of an intermediary heat exchange fluid. While engine fluids are typically around 150° C., an electrical heating element can go higher, e.g., 200° C. or higher, or 250° C. or higher.

Example C shows a volume heating element 472 extending through the walls of a pre-chamber 470 and in connection with the temperature control unit 456. The volume heating element 472 heats the fluids within the inner volume of the pre-chamber 470. Examples of the volume heating element 472 include a cartridge heater, resistance heater, hot surface ignitor, heat exchanging surface, or glow plug. In examples using an embedded heating element 462 or a volume heating element 472 to control the temperature of the pre-chamber 460/470, the temperature control unit 456 controls the temperature in a range from 50° C. to 250° C.

In examples A, B, and C, the temperature control unit 456 is connected to the pump 452, embedded heating element 462, or volume heating element 472, respectively, and receives information on a temperature value within the associated pre-chamber 450, 460, or 470. The temperature control unit 456 controls the pump 452, embedded heating element 462, or volume heating element 472 when a difference between the temperature value and a temperature set point is detected to change the temperature value to meet the set point, thereby regulating the temperature of the pre-chamber 450, 460, or 470. The pre-chambers 450, 460, or 470 and associated temperature control unit 456 can provide the pre-chamber 150 described herein.

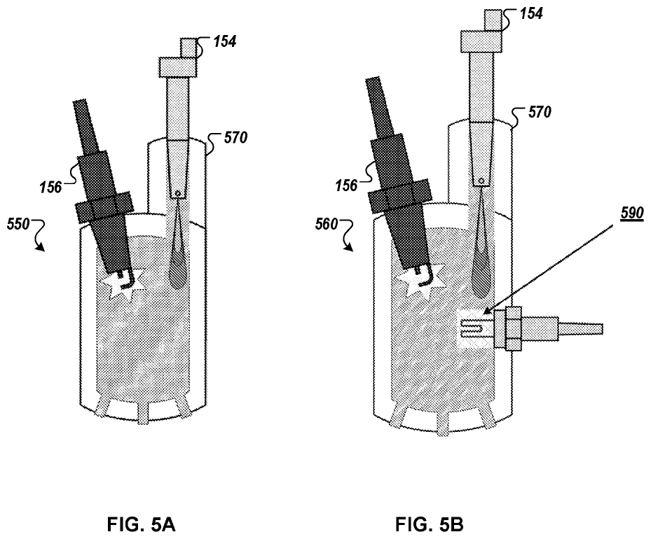

In some examples, the fuel injector 154 is recessed from the main inner volume to prevent damage to seals within the pre-chamber 150, such as pre-chambers which include additional heating elements, such as those described in FIG. 4. Referring now to FIG. 5A, a pre-chamber 550, which can provide pre-chamber 150, is shown in which the fuel injector 154 is recessed from the inner volume in which the ignition device 156 ignites the combustion mixture. The wall of the pre-chamber 550 extends upward in FIG. 5A to form a protrusion 570 through which the fuel injector 154 is inserted or installed. FIG. 5B shows another example in which a pre-chamber 560 includes the protrusion 570 for a recessed fuel injector 154 and includes a high-surface area heating element 590 onto which the fuel from the fuel injector 154 is sprayed. Spraying the fuel from the recessed fuel injector 154 onto the high-surface area heating element 590 heats the fuel before ignition which reduces potential heat lost to adiabatic expansion and longer spray distances over which the fuel is sprayed from the protrusion 570.

The high-surface area heating element 590 includes a resistive heating element surrounded by radiative structures which can include fins, porous media, pins, or dimples. The heating element 590 raises the temperature of the injected fuel to beneficially increase combustion characteristics without causing ignition.

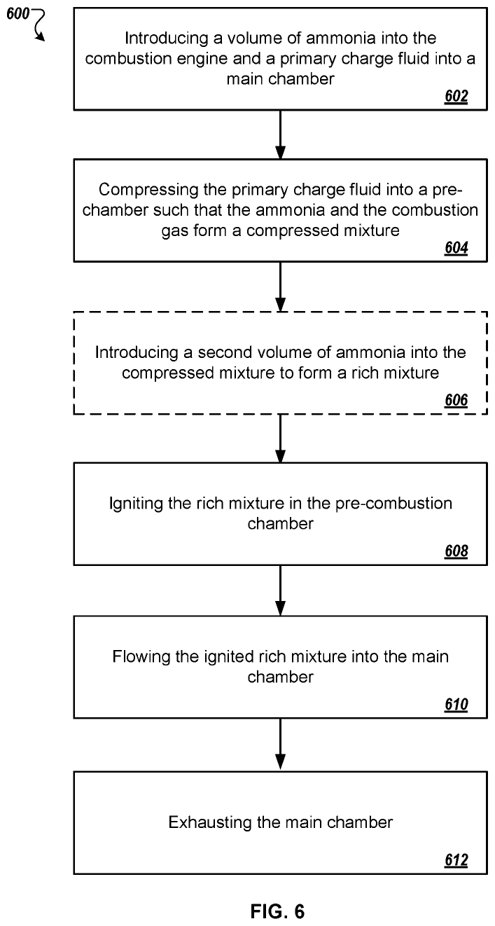

A method of burning ammonia that can be used with the systems and devices described herein is shown in the flowchart diagram of FIG. 6. The method 600 can include, during an intake stroke, introducing a volume of ammonia into a combustion engine and a primary charge fluid into a main chamber during an intake stroke of the combustion engine (step 602). In some examples, air flows from the intake port 110, through the intake valve 112, and into the main chamber 122 of the engine cylinder assemblies 100. Furthermore, in some examples, fuel injector 154 injects a volume of ammonia into the pre-chamber 150 to generate a primary mixture of fuel. Additionally, or alternatively, ammonia can be pre-mixed with the air entering through the intake valve 112 or can be injected separately using another injector into the main chamber 122.

The method 600 can include compressing the air into the pre-chamber 150 such that the primary charge fluid of fuel and air form a compressed mixture during a compression stroke of the internal combustion engine (step 604). In some examples, the piston 130 moves upward in the main chamber 122 and compresses the primary charge fluid into the pre-chamber 150 through the cylindrical orifice(s) 152. Furthermore, in some examples, primary charge fluid mixes with residual fluids from the previous cycle in the pre-chamber 150 to create a compressed mixture.

Optionally, the method 600 can include introducing a different volume of the fuel into the compressed mixture in the pre-chamber to form a rich mixture following the compression stroke (step 606). In some examples, the volume of fuel added to the compressed mixture in the pre-chamber is different from the volume of fuel that was added during the intake stroke. While the compressed mixture is in the pre-chamber 150, the fuel injector 154 injects a second volume of ammonia into the pre-chamber 150 to increase the fuel-air ratio of the compressed mixture, thereby increasing the φ value and creating a rich mixture.

The method 600 can include igniting the rich mixture in the pre-chamber (step 608). In an example, the ignition device 156 is a spark plug producing a spark which ignites the rich mixture in the pre-chamber 150. Alternatively, the rich mixture in the pre-chamber 150 is heated using a temperature control unit to raise the temperature of the fluids contained in the pre-chamber to facilitate easier ignition by the ignition device 156.

The method 600 can include flowing the ignited rich mixture into a main chamber of the cylinder during a power stroke of the internal combustion engine (step 610). As the ignited rich mixture is combusting, the piston 130 moves down away from the pre-chamber 150, which flows the combusting rich mixture through the cylindrical orifice(s) 152 into the main chamber 122. Flowing the combusting mixture into the main chamber 122 increases the hydrogen fraction in the main chamber and heats the main chamber fluids shortening combustion duration, thus increasing engine thermal efficiency. The rich mixture is formulated around the total cycle time of the power stroke 208 such that all ammonia is fully combusted within the duration of the power stroke 208. Optionally, the combusting rich mixture is ignited (e.g., secondary ignition) in the main chamber by an ignition device in the main chamber, different than ignition device 156 in the pre-chamber.

The method 600 can include exhausting the contents of the main chamber (step 612). The exhaust valve 142 opens and the piston 130 moves upward, displacing the combustion mixture from the main chamber 122 through the exhaust port 140. From this, the full engine cycle 200 resets to the intake stroke 202 corresponding to step 602.

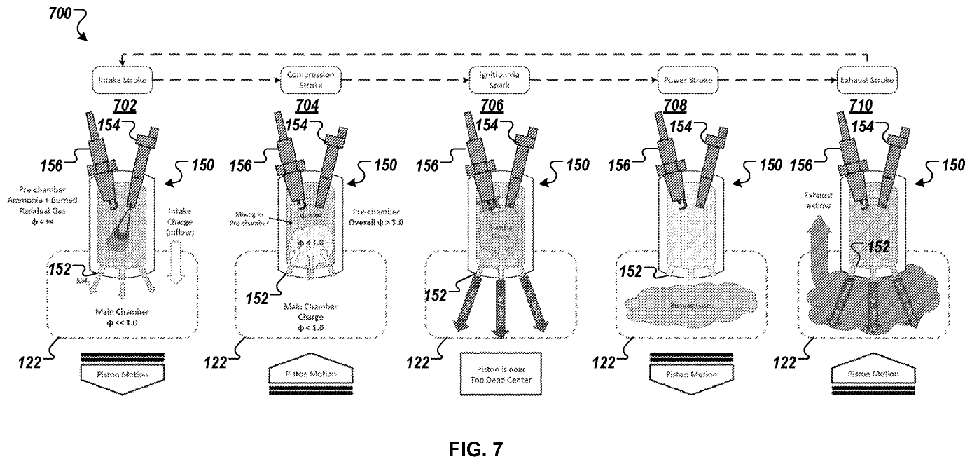

Additional examples of full combustion engine cycles are shown with reference to FIGS. 7-9. FIG. 7 is a diagram of an engine cycle 700 in which a single fuel injection step occurs in the pre-chamber 150 during the intake stroke 702. An engine cycle 700 utilizing a single fuel injection step uses a single injector 154 and is thus less mechanically complex than cycles including multiple injection steps. This provides cheaper manufacturing and reduced maintenance over the life of the engine. The timing and fuel-air ratio tuning of the single injection cycle 700 programmed in the engine controller is also simpler, reducing programming complexity. The single injection cycle 700 can also reduce mechanical upkeep for engines by reducing the number of total parts.

In some embodiments, fuel for the cycle 700 is injected by the fuel injector 154 into the pre-chamber 150 at the intake stroke 702. The pre-chamber 150 is at a rich φ and the main chamber 122 is at a lean φ. Without wishing to be bound by theory, substantially all of the fuel is in the pre-chamber 150, resulting in a ratio in the pre-chamber, φₚ, being much higher than in the ratio of the main chamber, φₘ, e.g., φₘ<<1.0, and φₚ>>φₘ.

A pressure difference is created between the main chamber 122 and the pre-chamber 150 by motion of the piston during the intake stroke 702. The gas from the intake port 110 flows into the main chamber 122 forming the primary charge. At least a portion of the fluid from the pre-chamber 150 flows into the main chamber 122 through the orifices 152.

The primary charge flows into the pre-chamber 150 during the compression stroke 704. The primary charge being pushed in the pre-chamber 150 through the pre-chamber orifices 152 mixes the injected fluid and the primary charge to form the fuel-air mixture.

The ignition device 156 ignites the fuel-air mixture in the pre-chamber 150 at the spark event 706. As described herein, the flame front consumes ammonia in the pre-chamber 150 and drives the combusting fuel-air mixture outward and further compresses the surrounding mixture. The compression causes reacting and unreacted mixtures to move from the pre-chamber 150 into the main chamber 122 through the orifice(s) 152.

The combusting mixture continues the combustion process of the fuel-air mixture within the main chamber 122 during the power stroke 708 thereby increasing main chamber pressure and driving the piston motion. Completion of the combustion reaction results in burned fluids within the pre-chamber 150 and main chamber 122. Motion of the piston forces the burned fluids out of the main chamber 122 during the exhaust stroke 710. The full engine cycle 700 is repeated following the exhaust stroke 710 by the initiation of the intake stroke 702.

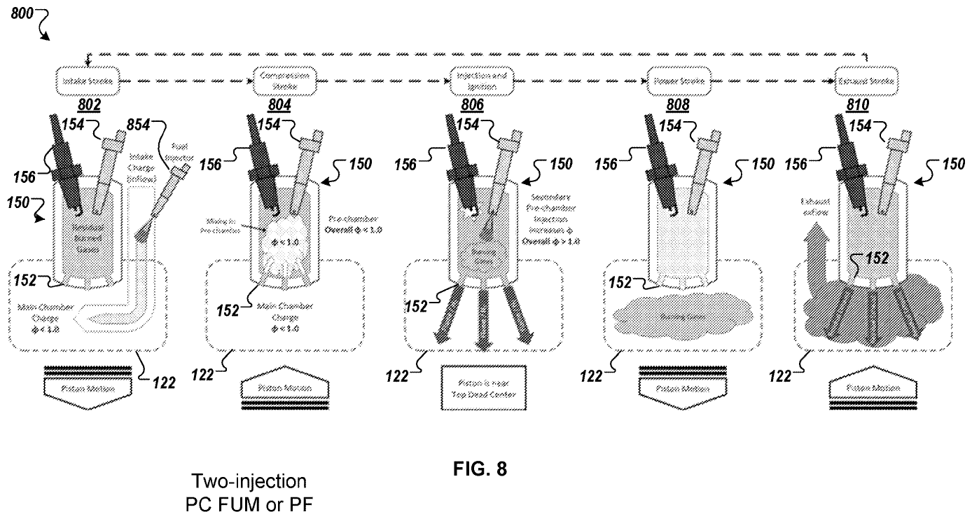

FIG. 8 is a diagram of an engine cycle 800 during which two fuel injection steps occur. One injection step occurs to introduce fuel to the main chamber 122 during the intake stroke 802 and a second injection step occurs in the pre-chamber 150 during the injection and ignition step 806. Engines performing the two-injection cycle 800 can benefit from increased fuel efficiency and power generation compared to single-injection cycles. Engines performing the two-injection cycle 800 can realize more control over the fuel-air mixture ratio in the pre-chamber to achieve more precise ratios.

A first portion of the fuel for the cycle 800 is injected by a fuel injector 854 into main chamber 122 at the intake stroke 802. Some examples of the cycle 800 include a fumigation cycle or a port-injection cycle. A fumigation cycle injects the fuel into the intake air stream during the intake stroke 802. This can include examples in which the fuel is injected by the first fuel injector 854 into the intake port 110 or into the main chamber 122 directly.

The piston creates the pressure difference between the main chamber 122 and the pre-chamber 150 during the intake stroke 702. The gas from the intake port 110 flows into the main chamber 122 and the first fuel injector 854 injects a portion of the fluid into the main chamber 122 to create a lean mixture in the main chamber 122, e.g., φₘ<1.0. The main chamber 122 being slightly lean provides an operating condition in which total air and fuel in both prechamber 150 and main-chamber 122 near-stoichiometric. This facilitates all the ammonia being combusted with little to no air remaining to produce NOx pollutant species, thus reducing the environmental impact of ammonia engines employing the pre-chamber 150.

One example of determining a ratio of first injection volume to second injection volume includes defining a ratio between the volumes of the prechamber 150 and main chamber 122. In one instance in which a prechamber 150 has 5% v/v of the main chamber 122, the first injection volume could be ~95% of that needed to make a stoichiometric mixture in the pre-chamber 150 and the main chamber 122. The second injection volume is then determined to bring the total injected volume to 100% of the fuel needed to make the stoichiometric mixture, e.g., 94.5% first injection volume, 5.5% second injection volume, 94% first injection volume, 6.0% second injection volume, etc.

The mixture is pushed into the pre-chamber 150 during the compression stroke 704. The mixture being pushed in the pre-chamber 150 through the pre-chamber orifices 152 mixes the injected fluid and the primary charge. The fuel-air mixture in the main chamber 122 and the pre-chamber 150 is lean, e.g., φₘ<1.0 and φₚ<1.0.

The fuel injector 154 injects a second portion of the fuel during the injection and ignition step 806. The second portion mixes with the fuel-air mixture in the pre-chamber 150 to increase the fuel-air ratio to create a rich mixture, e.g., φₚ>1.0.

The ignition device 156 ignites the rich fuel-air mixture in the pre-chamber 150 at the spark event 706. As described herein, the ignition causes reacting mixture to move from the pre-chamber 150 into the main chamber 122 through the orifice(s) 152.

The mixture continues the combustion process within the main chamber 122 during the power stroke 808. Motion of the piston forces the combusted mixture out of the main chamber 122 during the exhaust stroke 810. The full engine cycle 800 is repeated following the exhaust stroke 810 by the initiation of the intake stroke 802.

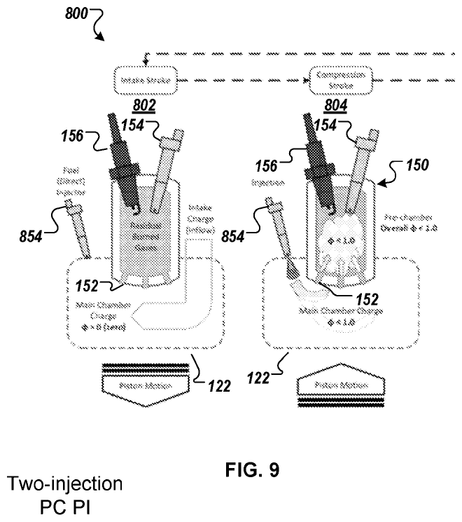

FIG. 9 is a diagram of the intake stroke 802 and compression stroke 804 of the engine cycle 800. The first fuel injector 856 is arranged to inject the first portion of fuel into the main chamber 122. The first injection step occurs in the main chamber 122 during the intake stroke 802. The primary charge of gas is drawn into the main chamber 122 during the intake stroke 802. The first fuel injector 856 injects the first portion of the fuel into the primary charge during the compression stroke 804. Motion of the piston drives the first fuel portion and the gas charge through the pre-chamber orifices 152. The first fuel portion creates the lean fuel-air mixture in the main chamber 122 and the pre-chamber 150. The second injection step occurs in the pre-chamber 150 during the injection and ignition step 806 and the cycle 800 proceeds through the power stroke 808 and the exhaust stroke 810 as shown in FIG. 8.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

### EXAMPLES

### Example 1—Orifice Area to Pre-Chamber Volume Ratio

Turbulent jets can be formed in fluid flow between the pre-chamber 150 and the main chamber 122 when significant pressure difference is developed between the two chambers. One example is when combustion is occurring in the pre-chamber 150; the expanding gases significantly increase the fluid pressure within the pre-chamber 150 compared to the main chamber 122. In another example and without expressing limitation, if main chamber 120 pressure is 20 bar, a pre-chamber 150 pressure that is at least 1 bar higher than the main chamber 122 pressure produces turbulent jets from the orifices 152. A lower pressure differential (e.g., less than 1 bar difference) and the ignited pre-chamber 150 produces a less energetic flame propagation, which can be called “torch ignition” in some instances.

Therefore, the cylinder assembly 100 is configured to develop a net pressure difference of 1 bar or greater between the pre-chamber 150 and the main chamber 122. In general, and without expressing limitation, the pressure difference between the pre-chamber 150 and the main chamber 122 is determined by the TCA of the orifices 152.

For pre-chamber volumes from 5% V/V of the main chamber clearance volume to 20% V/V, there exists a maximum TCA/V from which turbulence is no longer generated, and a minimum TCA/V from which flow restrictions overcome benefits from the turbulence generated.

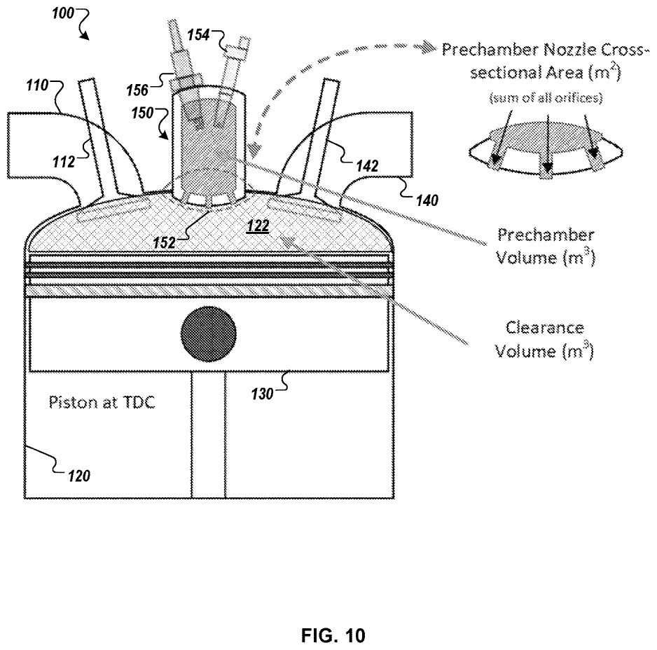

Referring to FIG. 10, a diagrammatic view of the cylinder assembly 100 with the piston 130 at TDC is shown. Reference is made herein to ‘Clearance Volume’ (CV) which is defined as the main chamber 122 volume when the piston 130 is at TDC, e.g., where piston 130 elevation is maximum and overall main chamber 122 volume is at a minimum. CV includes the pre-chamber 150 volume as the volume of both the pre-chamber 150 and main chamber 122 constitute the total free volume (TFV) when the piston 130 is at TDC. In general, the volume of the prechamber 150 is in a range from 5% to 20% v/v of the CV.

Reference is made herein to ‘orifice cross-sectional area’ which is defined as the sum of the cross-sectional areas of all orifices 152 fluidically connecting the pre-chamber 150 to the main chamber 122.

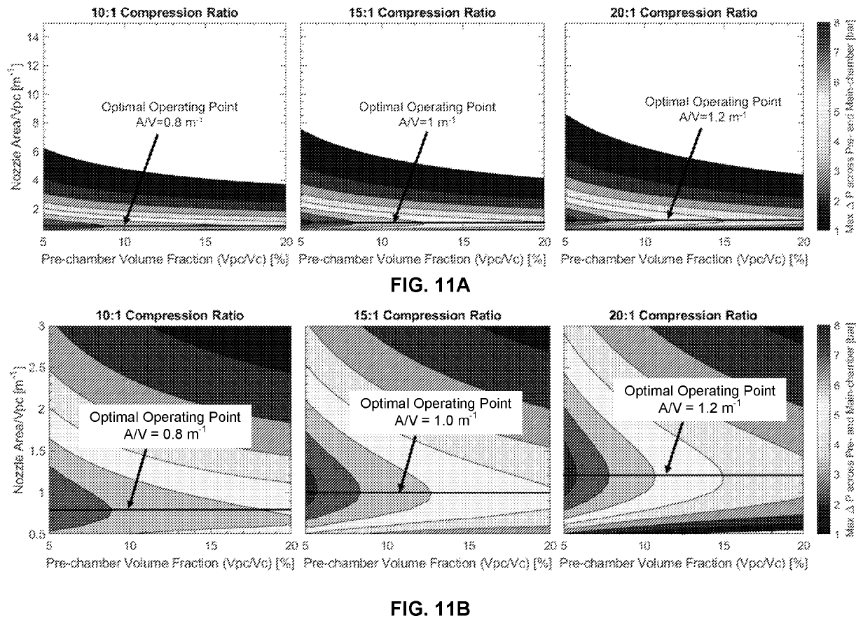

FIG. 11A is a series of three plot diagrams showing ammonia combustion modeling results. The three charts compare the pressure rise within the pre-chamber 150 and main chamber 122 (scale bar inset to right) compared to pre-chamber 150 volume fraction (e.g., in a range from 5% to 20% v/v, x-axis) and orifice 152 cross-sectional area to volume fraction (e.g., in a range from 0 to 15 m⁻¹, y-axis) for varied compression ratios (e.g., 10:1, 15:1, and 20:1 compression ratios shown inset to the top of each plot diagram).

FIG. 11B is the series of three plot diagrams of FIG. 11A showing a smaller orifice 152 cross-sectional area to volume fraction rage (e.g., in a range from 0.5 to 3 m⁻¹, y-axis). Optimum pressure rise is determined to be at a range of area to volume ratios of 0.8 m⁻¹, 1.0 m⁻¹, and 1.2 m⁻¹ at 10:1, 15:1, and 20:1 compression ratios, respectively. A horizontal line at the optimal operating point is shown in each plot diagram in FIGS. 11A and 11B.

Below this range (e.g., less than the Optimal Operating Point for each compression ratio), flow restrictions through the orifices 152 increase. The flow restrictions prevent combustible gas, e.g., air, and fuel, e.g., ammonia, from freely flowing between the pre-chamber 150 and the main chamber 122. In one example, pressure greatly increases in the pre-chamber 150 during combustion when the fuel-air mixture is heating and expanding. The increased pressure in the pre-chamber 150 reduces the flow rate of the combusting fuel-air mixture into the main chamber 122 and reduces turbulence generated during flow through the orifices 152. Maximum turbulence is generated at these optimum area to volume ratios identified in FIGS. 11A and 11B.

### Example 2—Spark Timing

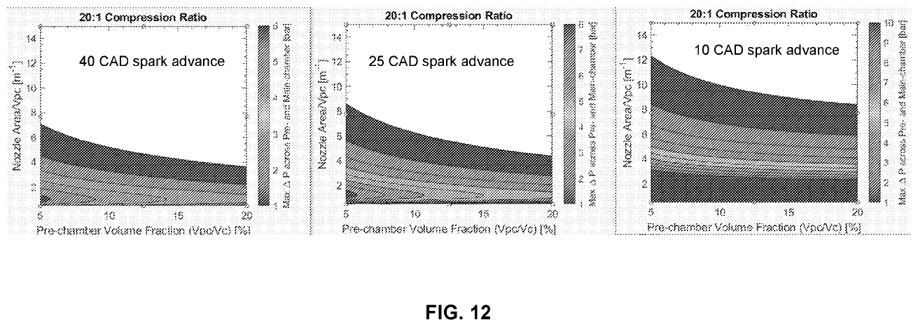

In some examples, the spark timing of the pre-chamber 150 can be varied to enhance turbulent flow through the orifices 152. FIG. 12 is a series of three plot diagrams showing ammonia combustion modeling results at various spark timings. The three charts compare the pressure rise within the pre-chamber 150 and main chamber 122 (scale bar inset to right) compared to pre-chamber 150 volume fraction (e.g., in a range from 5% to 20% v/v, x-axis) and orifice 152 cross-sectional area to volume fraction (e.g., in a range from 0 to 15 m⁻¹, y-axis) for a compression ratio of 20:1. The spark timing of the pre-chamber is varied from 40 degrees before TDC (left diagram) to 10 degrees before TDC (right diagram). The charts show the results when the spark is retarded from 40 to 10 crank angle degrees (CAD) from TDC. Such a range corresponds to that which generates effective turbulence. The area to volume ratio increases from a maximum of ~7.0 m⁻¹ to approximately 12 m⁻¹ as shown by the x-intercept points. Beyond this point, the range may be extended but the emergence of the turbulent jets may become too retarded to effectively ignite the main chamber and extract work from the combustion process.

At the upper limit, turbulent jets may not be generated. At the lower limit, combusting gases form a small, restricted jet leaving the orifices 152 with combustion energy being wasted/constrained to the pre-chamber. Engines using these values may operate is between the two values. Increased turbulence when values are closer to the lower limit may be realized for ammonia fuels due to desirability for high turbulence.

1. A method of operating a combustion engine, comprising:
introducing, during an intake stroke of an internal combustion engine, a volume of a fuel comprising ammonia into the combustion engine, and a primary charge fluid into a main chamber;
compressing, during a compression stroke of the internal combustion engine, the primary charge fluid into a pre-chamber such that the volume of the fuel and the primary charge fluid form a compressed mixture;
introducing, during the compression stroke, a different volume of the fuel into the compressed mixture present in the pre-chamber to form a rich mixture;
igniting the rich mixture in the pre-chamber; and
flowing, during a power stroke of the combustion engine, the ignited rich mixture into the main chamber.

2. The method of claim 1, further comprising inducing turbulent flow in the main chamber as the ignited rich mixture exits the pre-chamber.

3. The method of claim 1, where the volume is injected into the pre-chamber, the main chamber, or an intake port of the combustion engine.

4. The method of claim 1, further comprising igniting, following the flowing, the ignited rich mixture with an ignition device located in the main chamber.

5. The method of claim 4, wherein igniting comprises generating a spark, or a low-temperature plasma.

6. The method of claim 1, further comprising controlling a temperature of the pre-chamber.

7. The method of claim 6, wherein controlling the temperature of the pre-chamber comprises heating the pre-chamber.

8. The method of claim 7, wherein heating the pre-chamber comprises flowing a heat exchange fluid around the pre-chamber, electrically heating a wall of the pre-chamber, or heating a resistive element within the pre-chamber.

9-12. (canceled)

13. An ammonia-burning engine, comprising:
a plurality of combustion cylinders, each combustion cylinder comprising:
a main chamber;
a piston configured to move within the main chamber;
a pre-chamber fluidly coupled to the main chamber, wherein an internal volume of each pre-chamber is at least 5% v/v of an internal volume of the corresponding main chamber having a top dead center piston position;
a fuel injector configured to inject a liquid fuel comprising ammonia into the pre-chamber; and
an ignition device configured to generate a spark within the pre-chamber.

14. The engine of claim 13, further comprising a temperature control unit operatively coupled to each pre-chamber.

15-18. (canceled)

19. The engine of claim 13, wherein the ignition device is a spark plug, or a hot surface ignitor, or a nanosecond pulsed power supply to provide a low temperature plasma.

20. The engine of claim 13, each combustion cylinder further comprising a second fuel injector arranged to inject a liquid fuel into the main chamber, and a second ignition device configured to cause a spark within the main chamber.

21. The engine of claim 20, wherein the second ignition device is a spark plug, a hot surface ignitor, or a nanosecond pulsed power supply to provide a low temperature plasma.

22. The engine of claim 13, wherein the piston comprises a re-entrant bowl or shallow-dish in an upper surface of the piston.

23. The engine of claim 13, wherein the pre-chamber includes a protrusion extending away from an inner volume of the pre-chamber and the fuel injector is arranged to inject fuel into the protrusion.

24. The engine of claim 23, further comprising a high surface area heating element arranged in the pre-chamber arranged such that the fuel is injected onto the high surface area heating element.

25. The method of claim 3, where the volume of the fuel is introduced into the pre-chamber and the different volume is introduced into the main chamber or an intake port of the combustion engine.

26. The method of claim 3, wherein the different volume of the fuel introduced into the main chamber or intake port of the combustion engine is at most 95% of a total volume of the fuel introduced into the combustion engine.

27. The engine of claim 13, wherein the pre-chamber comprises orifices fluidly coupling the pre-chamber to the main chamber.

28-29. (canceled)

30. A method of operating a combustion engine, comprising:
introducing, during an intake stroke of an internal combustion engine, a volume of a fuel comprising ammonia into a pre-chamber of the combustion engine, and a primary charge fluid into a main chamber;
compressing, during a compression stroke of the internal combustion engine, the primary charge fluid into the pre-chamber such that the volume of the fuel and the primary charge fluid form a compressed mixture;
igniting the compressed mixture in the pre-chamber; and
flowing, during a power stroke of the combustion engine, the ignited rich mixture into the main chamber.
